(19) United States
(12) Patent Application Publication
(10) Pub. No.: US 2005/0065840 A1
(43) Pub. Date: Mar. 24, 2005

(54) Data collection supporting system, server, and data collecting method

(76) Inventors: Toyoji Ikezawa, Kanagawa (JP); Tsutomu Sasada, Aomori (JP)

Correspondence Address: MORRISON & FOERSTER LLP, 1650 TYSONS BOULEVARD, SUITE 300, MCLEAN, VA, 22102, US

(21) Appl. No.: 10/651,308

(22) Filed: Aug. 29, 2003

(30) Foreign Application Priority Data
Aug. 29, 2002 (JP) 2002-250725
Aug. 26, 2003 (JP) 2003-301576

(51) Int. Cl. G06F 17/60

(52) U.S. Cl. 705/11

(57) ABSTRACT

The server comprises deal data registration function, deal data analyzing function, deal data retrieval function and message transmission function, and is accessible to the deal DB. The server registers deal data given by the sales agent to the deal DB deal by deal, and analyzes the registered data to determine whether predetermined data items necessary for recognizing the deal status are failed or not. The server retrieves deal data record in which the necessary data items are failed, and prepares a message asking the sales agent to collect the failed information from the customer, and transmits it to the sales agent concerned.

### BACKGROUND OF THE INVENTION

1. Field of the Invention

The present invention relates to a data collection supporting system, server, and data collecting method suitable for collecting data in sales activities.

2. Description of the Related Art

U.S. patent application Ser. No. 10/101,860 discloses a technique for data entry regarding to business negotiations. According to this technique, data representing details of the business negotiations are registered in accordance with “Maturity Level”. This is helpful for sales agents or their supervisors to manage each of the business negotiations effectively.

FIG. 12 is a diagram for explaining the maturity level (progression level) in the sales activity. As shown in FIG. 12, the maturity level is categorized into “Level 1”, “Level 2”, and “Level 3”. Level 1 further includes the steps of “First Contact”, “Relation Establishment”, and “Investigation”. Level 2 also includes the steps such as “Show Attraction”, “Find out Demand”, and “Solution Planning”. And Level 3 has the steps of “Presentation”, “Problem Elimination”, and “Conclusion”. There are 9 steps in the maturity level.

Since a sales agent registers data of deals (business negotiations) along the progression, it requires data entry of each deal at every progression steps. That is, the total number of data entries increase day by day. Some of the deals may be concluded while the others are abandoned. A supervisor of the sales agent has daily tasks to check the data to make strategic decisions for their business at each progression step. During those tasks, the supervisor notifies the sales agent of the decision. If some articles necessary for making decision fail in the data entry, the supervisor must instruct the sales agent to fulfill the failed data. Such the management tasks have been burdens for the supervisors.

The present invention has been made as a solution for the above problems, and it is an object of the present invention to present a data collection supporting system, server, and data collecting method.

### SUMMARY OF THE INVENTION

To achieve the above objects, a data collection supporting system according to a first aspect of the present invention is a system which includes a server which collects data regarding to deals from terminal devices being connected to the server via a network, comprises:
data input means for inputting the deal data collected by a sales agent to the server via the network;
data storing means for storing the deal data input by the data input means;
data analyzing means for analyzing the deal data stored by the data storing means, to determine whether predetermined data items necessary for recognizing the deal status are failed or not; and
failure notification means for notifying the sales agent that the input deal data have failure.

The failure notification means may notify the sales agent to collect information for the failed data items.

The failure notification means may notify the sales agent of know-how for getting information out of a customer.

To achieve the above objects, a server according to a second aspect of the present invention is a server being connected with terminal devices via a network, comprises:
a data collecting unit which collects data regarding to business deals from the terminal device operated by a sales agent via the network;
a database which stores the deal data collected by the data collecting unit so as to be associated with information of the sales agents and customers;
a data analyzer which analyzes the deal data stored in the database deal by deal to determine whether predetermined data items necessary for recognizing the status of each deal are failed or not;
a message generator which generates a message representing that the collected deal data have failures when the failure is found; and
a message transmitter which transmits the message generated by the message generator to the terminal devices operated by the sales agent.

The message generator may generate the message for requesting the sales agent to collect information regarding to the failed data items from the customer.

The data analyzer may analyze the deal data in the database deal by deal to determine whether the deal data of each deal are completed or not;
the message generator may generate a message for requesting a supervisor of the sales agent to make business decision on the deal concerned, in a case where the data analyzer determines that the deal data concerned are completed; and
the message transmitter may transmit the message to a terminal device operated by the supervisor via the network together with the deal data of the deal concerned.

The database may further store know-how data representing know-how for getting information out of a customer;
the data analyzer may analyze the deal data stored in the database to select know-how data; and
the message transmitter may transmit the know-how data selected by the data analyzer to the terminal device operated by the sales agent.

The data analyzer may analyze the deal data stored in the database to determine whether the deal concerned should be continued or not.

To achieve the above objects, a data collecting method according to a third aspect of the present invention is a method for collecting data of business deals in a computer system including computers being connected from each other via a network, comprises the steps of:
collecting the deal data from a sale agent;
storing the collected deal data in a database;
analyzing the deal data in the database deal by deal to determine whether predetermined data items necessary for recognizing the deal status are failed from the deal data or not; and
notifying the sales agent that the deal data should be fulfilled, and requesting the sales agent to collect the failed information from a customer with notifying said sales agent of tips for getting information out of the customer, when it is determined that the predetermined data items are failed.

The method may further comprise the steps of:
analyzing the deal data in the database to determine whether the deal data are completed or not;
requesting a supervisor of the sales agent to determine whether the deal should be continued or not, in a case where it is determined that the deal data for the deal concerned are completed.

To achieve the above objects, a computer program product according to a fourth aspect of the present invention is a computer program product for causing a computer to execute a data collecting method comprising the steps of: collecting the deal data from a sale agent; storing the collected deal data in a database; analyzing the deal data in the database deal by deal to determine whether predetermined data items necessary for recognizing the deal status are failed from the deal data or not; notifying the sales agent that the deal data should be fulfilled, and requesting the sales agent to collect the failed information from a customer with notifying said sales agent of tips for getting information out of the customer, when it is determined that the predetermined data items are failed; analyzing the deal data in the database to determine whether the deal data are completed or not; and requesting a supervisor of the sales agent to determine whether the deal should be continued or not, in a case where it is determined that the deal data for the deal concerned are completed.

To achieve the above objects, a computer data signal according to a fifth aspect of the present invention is a computer data signal embodied in a carrier wave for causing a computer to execute a data collecting method comprising the steps of: collecting the deal data from a sale agent; storing the collected deal data in a database; analyzing the deal data in the database deal by deal to determine whether predetermined data items necessary for recognizing the deal status are failed from the deal data or not; notifying the sales agent that the deal data should be fulfilled, and requesting the sales agent to collect the failed information from a customer with notifying said sales agent of tips for getting information out of the customer, when it is determined that the predetermined data items are failed; analyzing the deal data in the database to determine whether the deal data are completed or not; and requesting a supervisor of the sales agent to determine whether the deal should be continued or not, in a case where it is determined that the deal data for the deal concerned are completed.

### BRIEF DESCRIPTION OF THE DRAWINGS

These objects and other objects and advantages of the present invention will become more apparent upon reading of the following detailed description and the accompanying drawings in which:

FIG. 1 is a schematic view showing the structure of a data collection supporting system according to the embodiments of the present invention;

FIG. 2 is a block diagram showing the structure of the server shown in FIG. 1;

FIG. 3 is a diagram exemplifying data recorded in a deal DB shown in FIG. 1;

FIG. 4 is a diagram exemplifying data recorded in an agent DB shown in FIG. 1;

FIG. 5 is a diagram exemplifying data recorded in a customer DB shown in FIG. 1;

FIG. 6 is a flowchart for explaining “Failure Notification” process according to the first embodiment of the present invention;

FIG. 7 is a flowchart for explaining “Decision Making” process according to the second embodiment of the present invention;

FIG. 8 is a flowchart for explaining “Know-how Notification” process according to the third embodiment of the present invention;

FIG. 9 is a diagram exemplifying “Advisory Notice” displayed on the terminal device;

FIG. 10 is a schematic view showing another structure of the data collection supporting system;

FIG. 11 is a schematic view showing still another structure of the data collection supporting system; and

FIG. 12 is a diagram for explaining “Maturity levels” of business deal.

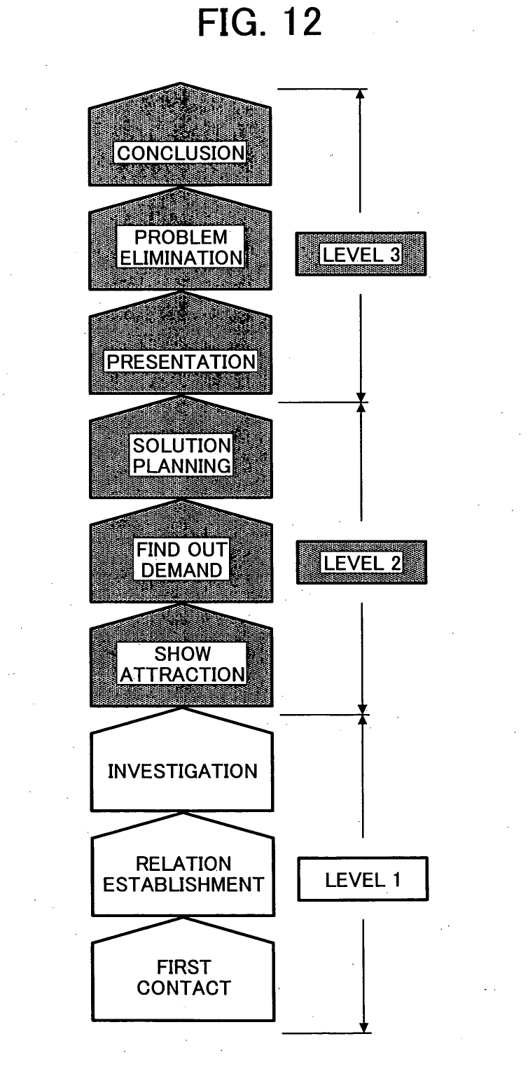

### DETAILED DESCRIPTION OF THE PREFERRED EMBODIMENTS

Preferred embodiments of the present invention will now be described with reference to the accompanying drawings.

### First Embodiment

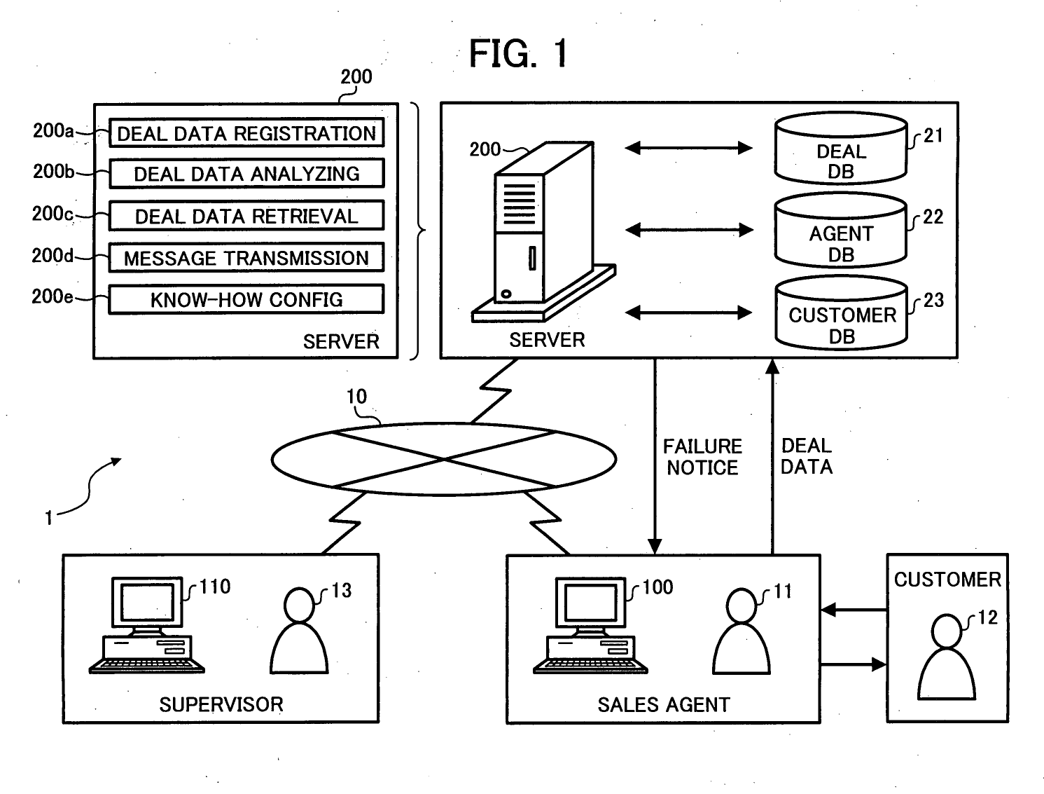

FIG. 1 is a schematic diagram showing the structure of a data collection supporting system according to the embodiments of the present invention. As shown in FIG. 1, the data collection supporting system 1 comprises a network 10, a terminal device 100 to be operated by a sales agent 11, another terminal device 110 to be operated by a supervisor 13, and a server 200 for supporting the data collection regarding to deals (business negotiations). The system 1 according to the embodiments of the present invention may be included in a computer network system of a business body (such as enterprise) to support their sales activities. Hereinafter, the business body concerned will be referred to as “Company R”.

The network 10 shown in FIG. 1 may be an enterprise network of the company R. The network 10 may be a complex of LAN (Local Area Network), WAN (Wide Area Network), and the like for connecting the server 200 and the terminal devices 100 and 110 with each other. In a case where the server 200 and the terminal devices 100 and 110 are located in the same local area, the network 10 acts as LAN, while the network 10 acts as WAN when those nodes are not located in the same local area. In case of LAN, it may be a network based upon IEEE 802.3 or 802.11x which carries data in accordance with predetermined protocol such as TCP/IP (Transmission Control Protocol/Internet Protocol). In case of WAN, it may be the Internet or MAN (Metropolitan Area Network) which also transfers data under the predetermined protocol such as TCP/IP. The network 10 may include various connection means such as wired connection, wireless connection, leased line connection, PSTN (Public Switched Telephone Network) connection, or Intranet. It is preferable that the network 10 has appropriate security techniques such as exclusive communications with leased line, data encryption, and user authentication.

The terminal device 100 may be a data processing terminal such as a personal computer (PC). Operation of the terminal device 100 will be done by the sales agent 11 to input information of the deal held between the sales agent 11 and a customer 12. The terminal device 100 comprises predetermined control unit, storage, and input/output devices. In addition to those fundamental components, the terminal device 100 also has means for connecting to the server 200 via the network 10. More precisely, it may be a predetermined telecommunication device such as NIC (Network Interface Card) in a case where the network 10 is LAN. It also may be a telecommunication device such as a modem, router, and TA (Terminal Adapter) when the network 10 is WAN. Though FIG. 1 show the terminal device 100 singly, a plurality of the terminal devices 100 may be connected to the server 200 via the network 10.

The terminal device 110 has the same structure as that of the terminal device 100. The terminal device 110 will be operated by a supervisor 13 of the sales agent 11.

Though desktop PCs are shown as the terminal devices 100 and 110 in FIG. 1, arbitrary devices may act as the terminal devices 100 and 110. For example, a cell phone, a mobile PC, and the like are also applicable ones. In a case where the company R has multiple terminal devices being applicable to the system 1, those devices may be connected to each other via LAN.

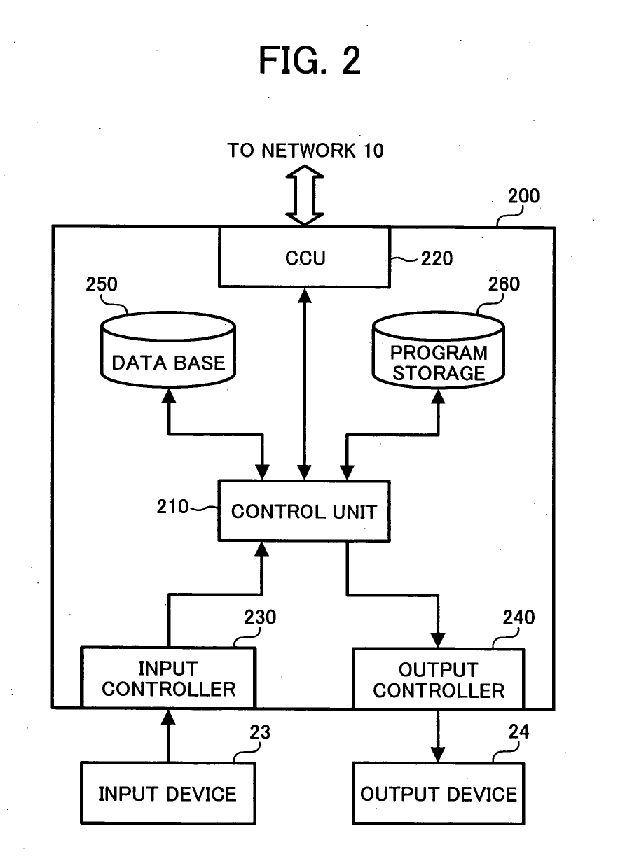

The server 200 collects data from the terminal devices 100 via the network 10, and stocks the collected data in databases. The server 200 also provides the sales agent 11 with predetermined information based on the collected data. Though a preferable location of the server 200 may be a headquarter of the company R, it may be located in a sales department office, ISP (Internet Service Provider), or the like even if the server 200 is connected to the network 10. The structure of the server 200 will now be described with reference to FIG. 2.

FIG. 2 is a block diagram showing the structure of the server 200. As shown in FIG. 2, the server 200 comprises a control unit 210, a communication control unit (CCU) 220, an input controller 230, an output controller 240, a database unit 250, and a program storage 260. The control unit 210 comprises a CPU (Central Processing Unit), a predetermined memory (for example, RAM (Random Access Memory)) as a work area, and the like. The control unit 210 controls the components in the server 200 and executes predetermined programs in the program storage 260 to realize the processing tasks described later.

The CCU 220 may be a predetermined telecommunication device such as a NIC. The CCU 220 connects the server 200 to the network 10 for data communications with the terminal devices 100 and 110.

The input controller 230 accepts predetermined input devices 23 such as a keyboard and pointing devices, and transfers data or commands input by those input devices, 23 to the control unit 210.

The output controller 240 accepts predetermined output devices 24 such as a display and a printer, and transfers result data and the like given by the control unit 210 to those output devices 24.

The database unit 250 may be a predetermined storage devices such as a hard disk drive to stores information given by the terminal device 100 with categorizing the data. The database unit 250 includes databases such as a deal DB 21, an agent DB 22, and a customer DB 23 as shown in FIG. 1.

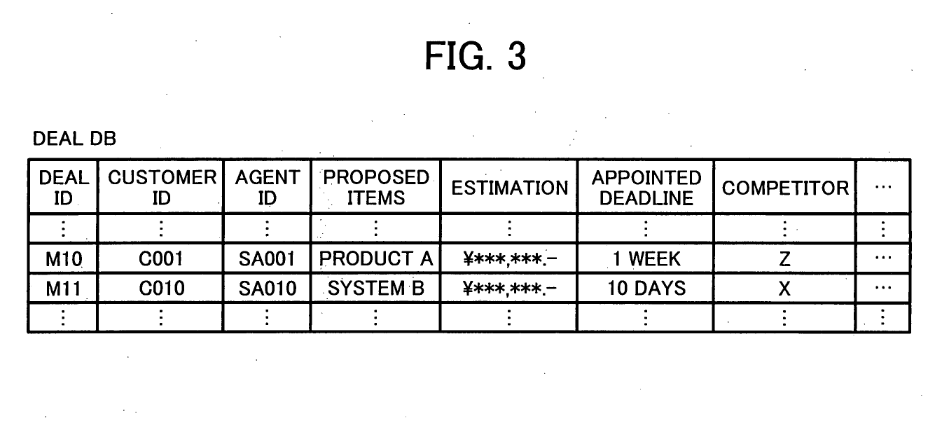

The deal DB 21 stores “deal data” input by the terminal device 100. The deal data represents details of deals (business negotiations). FIG. 3 is a diagram exemplifying the data being stored in the deal DB 21. As shown in FIG. 3, the deal DB 21 includes records each having “Deal ID” as a primary key. “Deal ID” is uniquely assigned to each deal. Each record includes items such as “Customer ID”, “Agent ID”, “Proposed Items”, “Estimation”, “Appointed Deadline”, and “Competitor”.

“Customer ID” represents a customer who joins the deal concerned.

“Agent ID” represents a sales agent who joins the deal concerned.

“Proposed Items” represents items or products proposed by the sales agent during the deal concerned.

“Estimation” represents estimate presented by the sales agent during the deal concerned.

“Appointed Deadline” represents deadline for shipping the items or products after the deal is concluded.

“Competitor” represents other competitive business bodies regarding to the items or services concerned.

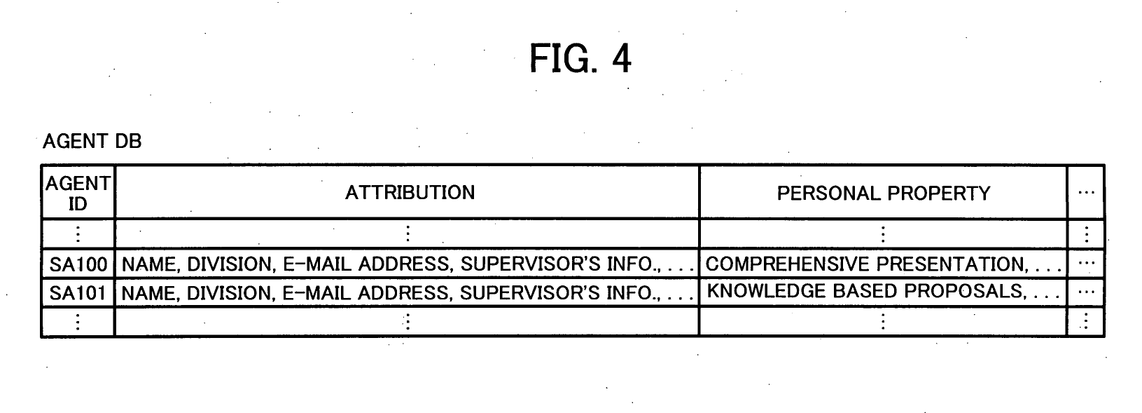

The agent DB 22 stores information about the sales agents or other workers of the company R. FIG. 4 is a diagram exemplifying data stored in the agent DB 22. As shown in FIG. 4, the agent DB 22 includes records each having “Agent ID” as a primary key. “Agent ID” is uniquely assigned to each sales agent. Each record further includes items such as “Attribution” and “Personal Property”.

“Attribution” is attributive data of the sales agent concerned which representing name, division, post, e-mail address, and the like. “e-mail address” represents one by which the sales agent concerned receives e-mails by the terminal device 100 assigned to the sales agent concerned. “Attribution” also includes information about the supervisor of the sales agent concerned. It includes at least “Agent ID” and “e-mail address” of the supervisor concerned. “e-mail address” of the supervisor represents one by which the supervisor concerned receives e-mails by the terminal device 110 assigned to the supervisor concerned.

“Personal Property” represents advantages, disadvantages or habits of the sales agent relating to the business.

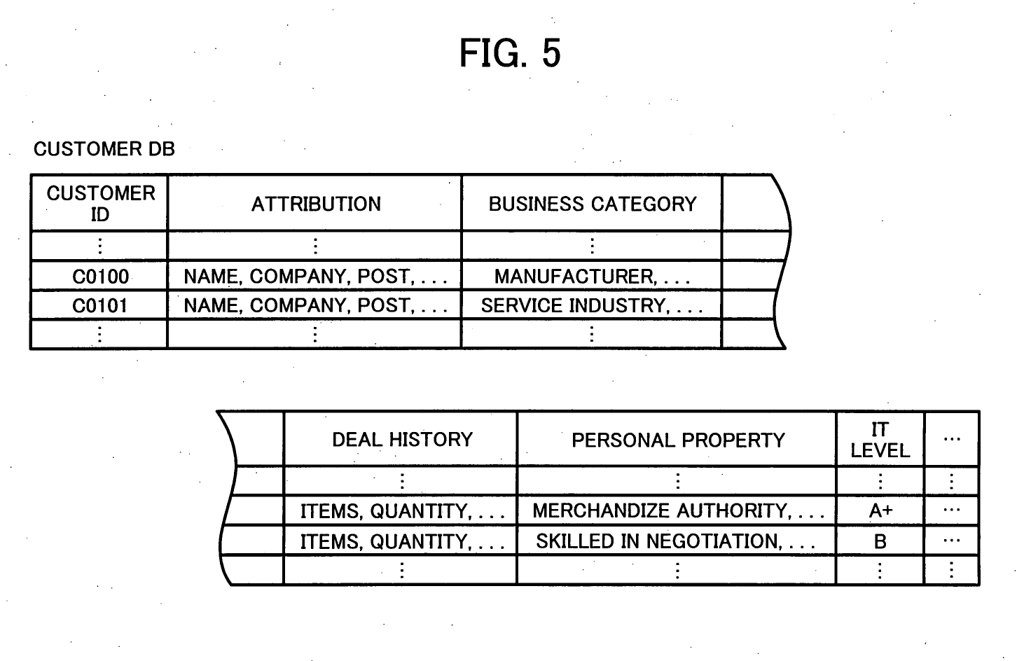

The customer DB 23 stores information regarding to the customers. FIG. 5 is a diagram exemplifying the data stored in the customer DB 23. As shown in FIG. 5, the customer DB 23 has records each having “Customer ID” as a primary key. “Customer ID” is uniquely assigned to each customer. Each record further includes items such as “Attribution”, “Business Category”, “Deal History”, “Personal Property”, and “IT Level”.

“Attirbution” is attributive data of a customer concerned such as name, company, and post.

“Business Category” represents business category of the company to which the customer concerned is belonging. Additionally, it includes information representing the business entity, for example, the number of workers, business areas, and the like.

“Deal History” represents deals between the company R and the customer concerned those have been held so far. It may also includes information about dealt items and their quantities.

“Personal Property” represents advantages, disadvantages or habits of the person in charge relating to the business negotiations.

“IT Level” is rating of the customer concerned in view of IT (Information Technology) progression. The rating is based on, for example, saturation levels of the computer network, PC, and the like.

Though the present embodiment exemplifies a case where the system 1 includes the deal DB 21, the agent DB 22, and the customer DB 23, the agent DB 22 and/or the customer DB 23 may be omitted from the system 1. And the databases may not be included in the server 200. For example, those databases may be away from each other but being connected to the server 200 via the network 10.

The other components of the server 200 will now be described with reference to FIG. 2.

The program storage 260 may be a predetermined storage device such as a hard disk drive and ROM (Read Only Memory). The program storage 260 stores various programs to be executed by the control unit 210, such as OS (Operating System). In addition to the OS, the program storage 260 stores the following programs those realize processing tasks by the server 200 described later.

“Communications Program” for controlling the CCU 220 to realize data communications between the terminal devices 100 and 110 via the network 10.

“DB Controller Program” for controlling the database unit 250 to input or output the data.

“Data Analyzer Program” for analyzing data stored in the database unit 250.

“Mail Server Program” for functioning the server 200 as a mail server which prepares predetermined e-mails based on the data analysis, transmits/receives or manages e-mails, and the like.

“Web Server Program” for functioning the server 200 as a web server which prepares or maintaining a web site as interface between the server 200 and the terminal devices 100 and 110.

According to execution of the above programs by the control unit 210, the server 200 has the functions of deal data registration 200a, deal data analyzing 200b, deal data retrieval 200c, message transmission 200d, and know-how configuration 200e, as shown in FIG. 1.

The deal data registration function 200a registers deal data input by the terminal device 100 to the deal DB 21.

The deal data analyzing function 200b analyzes the deal data registered by the deal data registration function 200a to determine whether the deal data fail to have necessary data items or not. Necessary data items may be arbitrarily ones selected from the items shown in FIG. 3. In this embodiment, at least any one of or all of “Proposed Items”, “Estimation”, “Appointed Deadline”, and “Competitor” are the necessary data items. The necessary data items may be selected arbitrary in accordance with the deals. For example, “Comment by the sales agent” or “Response from the customer” may be one of them.

The deal data retrieval function 200c retrieves records which fails one or all of the necessary data items. The deal data retrieval function 200c also accepts data items which are scheduled to be collected when the sales agent 11 contacts or visits the customer 12 next time. In this case, the deal data analyzing function 200b analyzes the data items to determine whether predetermined data items have been collected or not. The deal data retrieval function 200c retrieves deal data record in which some or all of the predetermined data items are failed. According to this function, the server 200 is able to determine whether predetermined data items are failed or not when the sales agent 11 contacts or visits the customer next time.

The message transmission function 200d transmits a message to the terminal device 100 when the deal data analyzing function 200b determines the deal data fail to have necessary data items, to notify the sales agent concerned to collect the failed information from the customer.

The know-how configuration function 200e sets tips for collecting information (know-how). The know-how represents tips for getting information out of the customer in accordance with the property of each sales agent, such as advantages, disadvantages, habits and the like.

Arbitrary configurations may be acceptable for designing those functions. For example, the message transmission function 200d and/or the know-how configuration function 200e may be omitted from the server 200. A computer having multiple servers such as a network server and an authentication server may be applicable one, even if it able to execute the programs for realizing the above mentioned functions. It is preferable that those programs are compatible with GUI (Graphical User Interface) for easier operations.

Though a single computer machine is exemplified as the server 200 in this embodiment, the physical structure of the server 200 is not limited to that. The functions of the server 200 may be distributed to multiple computer machines being connected to each other via various networks.

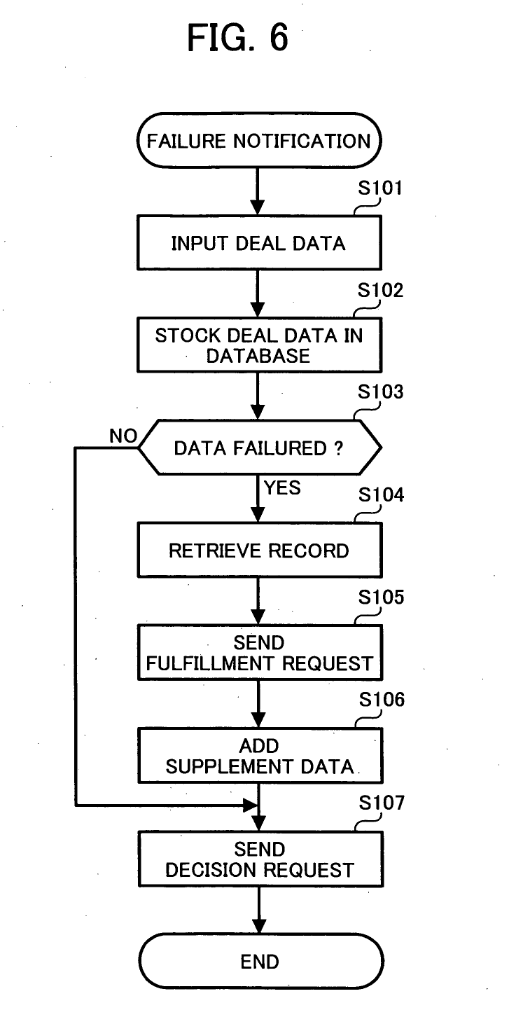

Operations and actions in thus structured system 1 will now be described. Processing of “Failure Notification” executed by the server 200 will now be described with reference to a flowchart shown in FIG. 6. The server 200 executes the above described programs, thus the deal data registration function 200a, the deal data analyzing function 200b, the deal data retrieval function 200c, the message transmission function 200d, and the know-how configuration function 200e collaborate with each other to realize the following processing tasks. “Failure Notification” processing starts in response to the access from the terminal device 100. The server 200 executes the web server program to have an interface web page for accepting the access from the terminal device 200. When the server 200 is accessed by the terminal device 100, the server 200 performs predetermined user authentication based on user ID and password those assigned to the sales agents.

In response to the authentic access from the terminal device 100, the deal data registration function 200a accepts the deal data from the terminal device 100 (step S101). The deal data may be collected by the sales agent 11 through the daily sales activities. The deal data registration function 200a registers the deal data to the deal DB 21 deal by deal (step S102). The deal data are stocked in the deal DB 21 as history of the sales activities.

Then the deal data analyzing function 200b analyzes the deal data in the deal DB 21 to determine whether necessary data items are failed or not (step S103). If it is determined that there is a record in which some or all of the necessary data items are failed (step S103: Yes), the deal data retrieval function 200c retrieves the record concerned (step S104). This process may be done at every data entry, or by batch processing.

The message transmission function 200d obtains e-mail address of the sales agent 11 who input the deal data concerned, from the agent DB 22 based on the agent ID in the retrieved record. In accordance with operations of the mail server program, the message transmission function 200d prepares an e-mail for notifying the sales agent 11 concerned that some necessary data items are failed and those should be fulfilled after getting information out of the customer (hereinafter, the e-mail concerned will be referred to as “Failure Notice”). The failure notice indicates which data items are failed. The message transmission function 200d transmits the failure notice to the e-mail address of the sales agent 11 concerned.

The terminal device 100 assigned to the sales agent 11 concerned receives the failure notice from the server 200. The sales agent 11 concerned may contact the customer to collect information to fulfill the deal data. The sales agent 11 inputs the collected information to the terminal device 100 for the fulfillment (hereinafter, the information concerned will be referred to as “fulfillment data”).

The deal data registration function 200a of the server 200 accepts the fulfillment data from the terminal device 100, and adds the fulfillment data to the record retrieved at step S104 (step S106).

In response to the additional registration, the message transmission function 200d specifies the supervisor 13 of the sales agent 11 concerned based on the agent data record in the agent DB 22, and obtains e-mail address of the specified supervisor 13. The message transmission function 200d prepares an e-mail including the contents of the deal data record and a message asking the supervisor 13 to make business decisions (hereinafter, the e-mail concerned will be referred to as “Decision Request”). The message transmission function 200d transmits the decision request to the e-mail address of the supervisor 13 concerned (step S107).

The terminal device 110 assigned to the supervisor 13 concerned receives the decision request from the server 200. The supervisor 13 refers the contents of the decision request, and makes decision, for example, whether the deal should be continued or not.

On the other hand, if there is no failures in the deal data registered at step S102 (step S103: No), the message transmission function 200d immediately prepares the decision request based on the registered deal data and transmits it to the terminal device 110 of the supervisor 13 (step S107). In this case, the supervisor 13 also makes decision based on the decision request.

According to the above process, the deal data input by the sales agent 11 are analyzed whether necessary data items are failed or not, and the failure notice is transmitted to the sales agent 11 automatically if the necessary data items are failed. This is helpful for smoother data collection to be carried out by the sales agent 11. Moreover, the completed deal data are automatically notified to the supervisor 13, thus the supervisor 13 is released from troublesome management tasks.

### Second Embodiment

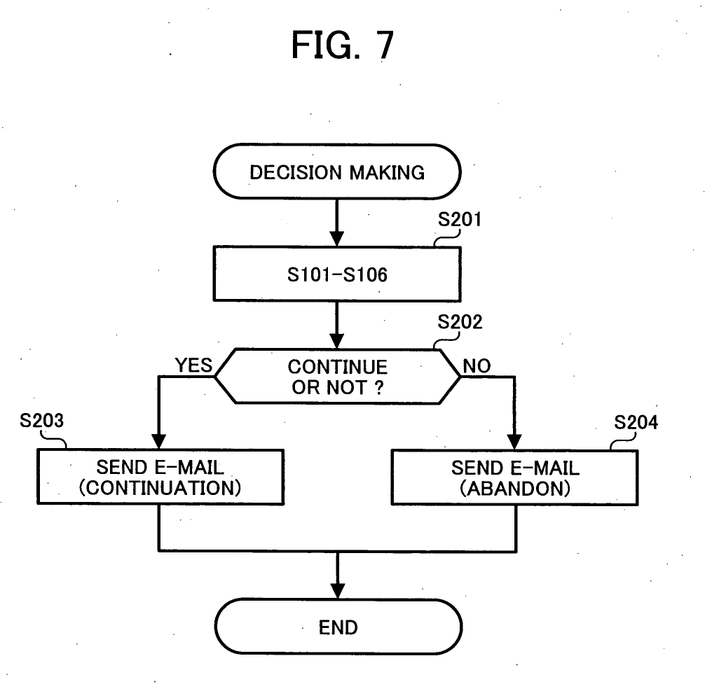

Though the supervisor 13 makes decision based on the notified deal data in the above described first embodiment, the server 200 may carry out such the decision making. “Decision Making” process to be executed by the server 200 will now be described with reference to a flowchart shown in FIG. 7.

After the completed deal data are registered in the deal DB 21 through the steps S101-S106 in “Failure Notice” process shown in FIG. 6 (step S201), the deal data analyzing function 200b of the server 200 accesses the database unit 250 to retrieve deal data, information of the sales agent 11 who handles the deal concerned, information of the customer of the deal concerned, and the like. The deal data analyzing function 200b analyzes the retrieved data and makes decision whether the deal concerned should be continued or not (step S202).

The deal data analyzing function 200b may make decision based on, for example, the maturity level of the deal concerned, previous results of the sales agent 11 concerned, purchase history of the customer concerned, and the like.

In a case where the deal data analyzing function 200b determines that the deal should be continued (step S202: Yes), the message transmission function 200d prepares an e-mail indicating that the deal should be continued (hereinafter, referred to as “Continuation Notice”), and transmits it to the e-mail address of the sales agent 11 (step S203).

On the contrary, if the deal data analyzing function 200b determines that the deal should not be continued (step S202: No), the message transmission function 200d prepares an e-mail indicating that the deal should be abandoned (hereinafter, referred to as “Abandonment Notice”), and transmits it to e-mail addresses of the sales agent 11 and the supervisor 13 (step S204).

After the continuation notice or the abandonment notice is sent, the server 200 terminates the “Decision Making” process.

According to the above processing, the supervisor 13 will be released from troublesome managing tasks because the server 200 makes decision whether the deal should be continued or not. This is helpful for improving the business efficiency. The server 200 may make various decisions necessary for the business. For example, the server 200 may determine whether the sales agent should be changed or not, or select items (products) to be proposed to the customer.

### Third Embodiment

Though the server 200 sends the failure notice if the registered deal data have failures in the above first and second embodiments, the server 200 may notifies the sales agent 11 of know-how (tips for data collection) for getting information out of the customer effectively. To achieve this function, the database unit 250 has a know-how DB 24 additionally.

The know-how DB 24 stores advisory information representing tips for collecting information (know-how) in accordance with various patterns of target event, personal property of the sales agent 11, personal property of the customer 12, customers IT level, and the like. The information stored in the know-how DB 24 are set by the know-how configuration function 200e of the server 200.

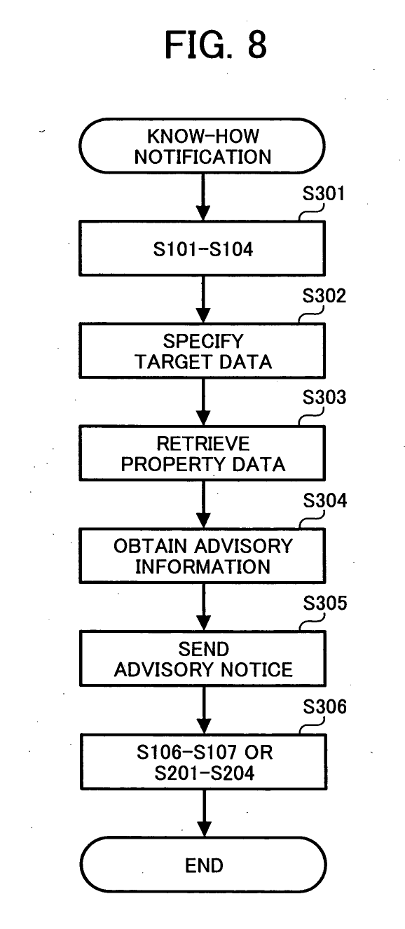

Process for notifying the sales agent 11 of the advisory information (“Know-how Notification”) will now be described with reference to a flowchart shown in FIG. 8.

After the deal data retrieval function 200c retrieves a failed deal data record through steps S101-S104 in the failure notification process shown in FIG. 6 (step S301), the deal data analyzing function 200b specifies the failed data items, the sales agent 11, and the customer 12 based on the retrieved deal data record (step S302).

The deal data retrieval function 200c retrieves the personal property data of the specified sales agent 11 from the agent DB 22, and retrieves the personal property data of the specified customer 12 from the customer DB 23 (step S303).

The deal data retrieval function 200c further retrieves appropriate advisory information from the know-how DB 24 based on the failed data items specified at step S302 and personal properties retrieved at step S303 (step S304).

The message transmission function 200d prepares an e-mail including the advisory information retrieved at step S304 (hereinafter, referred to as “Advisory Notice”), and transmits it to the e-mail address of the sales agent 11 concerned (step S305).

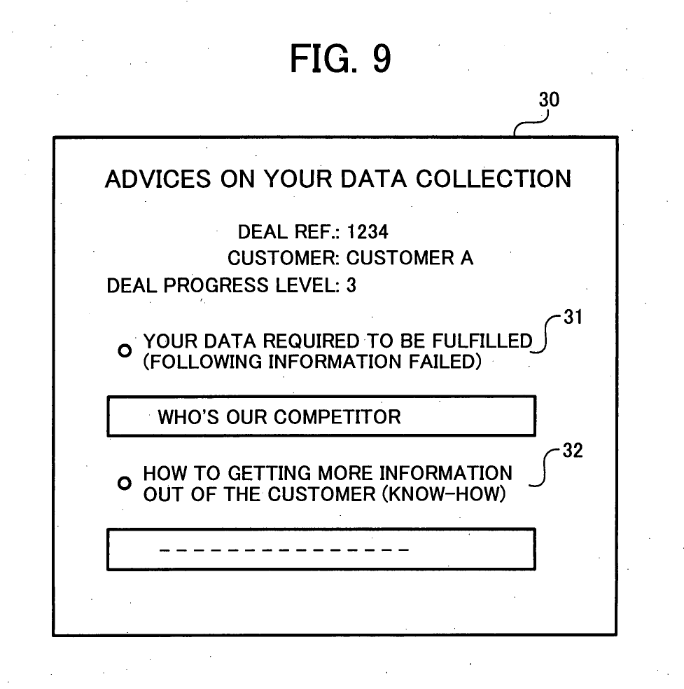

FIG. 9 is a diagram showing an example of the advisory notice 30. As shown in FIG. 9, the advisory notice 30 includes failed item indication 31 and know-how indication 32. The advisory notice 30 shown in FIG. 9 indicates that information about competitor has been failed. The sales agent 11 refers the advisory notice 30 and recognizes which information is failed. Moreover, the advisory notice 30 also includes the know-how indication 32, thus the sales agent 11 may contact the customer to get the information out of the customer with reference to the advisory information indicating the know-how.

Hereinafter, steps S106-S107 shown in FIG. 6 or steps S201-S204 shown in FIG. 7 are carried out to add the fulfillment data or make decision.

According to the above processing, the sales agent 11 is effectively advised how to get information out of the customer based on personal properties (advantages, disadvantages, habits, and the like) of the sales agent 11 and the customer 12. In other words, the sales agent 11 is able to collect necessary information from the customer promptly and smoothly, because the advisory information for getting information out of the customer is automatically provided to the sales agent 11. Though the appropriate advisory information is selected based on the property data of both the sales agent 11 and the customer 12, the selection may be done based on the property data of the sales agent 11 or the customer 12.

The know-how configuration function 200e may carry out predetermined categorization based on the property data of the sales agent 11 and the customer 12, and set advisory information corresponding to the categories.

Though the single computer machine acts as the server 200 in the above embodiments, the physical structure of the server 200 is not limited to that.

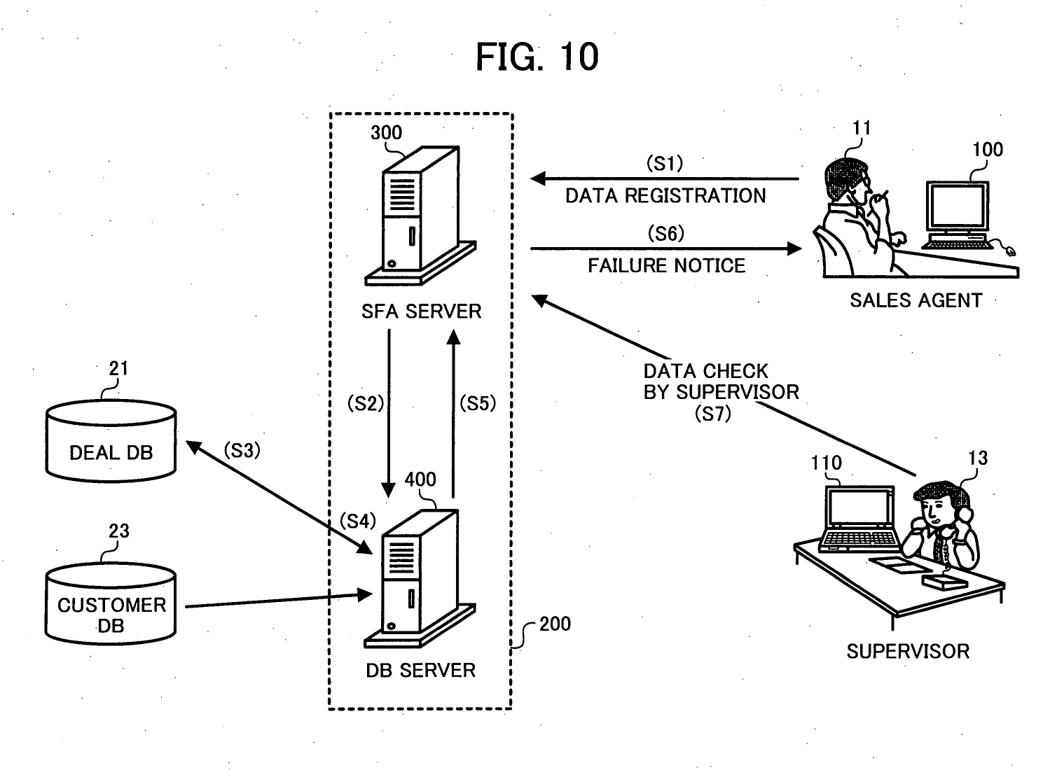

FIG. 10 is a schematic diagram exemplifying another configuration of the data collection supporting system 1. As shown in FIG. 10, the server 200 comprises an SFA (Sales Force Automation) server 300 and a DB server 400, and the server 200 is connected to the terminal device 100 operated by the sales agent 11 and the terminal device 110 operated by the supervisor 13 via the network 10. In other words, the server 200 according to this embodiment comprises two server devices those are functionally different from each other.

The sales agent 11 inputs deal data collected through daily sales activities to the SFA server 300 via the terminal device 100 (S1). The SFA server 300 transmits the input deal data to the DB server 400 (S2). The DB server 400 registers the deal data given by the SFA server 300 to the deal DB 21 deal by deal as deal activity history (S3).

Then the DB server 400 analyzes each of the registered deal data to determine whether predetermined data items necessary for recognizing the deal status are failed or not. Based on the analysis, the DB server 400 retrieves deal data record in which some or all of the predetermined necessary data items are failed (S4). The DB server 400 also transmits information for notifying that the predetermined necessary data items are failed from the registered deal data to the SFA server 300 (S5). The above analysis and retrieval actions may be performed by the SFA server 300. Then the SFA server 300 prepares a message notifying the sales agent 11 that the sales agent 11 concerned should collect information regarding to the failed necessary data items, and transmits the message to the sales agent 11 concerned (S6). The supervisor 13 also refers the message transmitted to the sales agent 11 (S7).

The sales agent 11 who receives the message from the SFA server 300 (more precisely, the message transmission function 200d) may contact the customer to collect the information. The SFA server 300 accepts the additionally collected information from the sales agent 11, and registers the information to the deal DB 21. In response to the data entry in accordance with the message transmitted by the SFA server 300 (message transmission function 200d), the SFA server 300 transmits the registered deal data to the terminal device 110 (supervisor's terminal) deal by deal. Thus, the supervisor 13 is able to make decision whether the deal should be continued or not based on the deal data given by the SFA server 300.

Instead of the above actions, the SFA server 300 or the DB server 400 may make decision whether the deal should be continued or not in response to the data entry by the sales agent 11 who followed the message transmitted to the sales agent 11 from the SFA server 300 (message transmission function 200d). In this case, the SFA server 300 or the DB server 400 notifies the supervisor 13 and/or the sales agent 11 of the decision.

According to the above structure, the system 1 supports the activities for collecting failed data. More precisely, the supervisor 13 is able to make decision quickly and finely just after the collected data are registered to the deal DB 21. As a result, it is helpful for shortening the term of each business deal thus productivity through the sales activity will improve, because the system 1 supports the data collection regarding to the failed data. Moreover, it also realizes effective usage of the human resources, because the supervisor 13 handles more sales agents 11 through the management tasks.

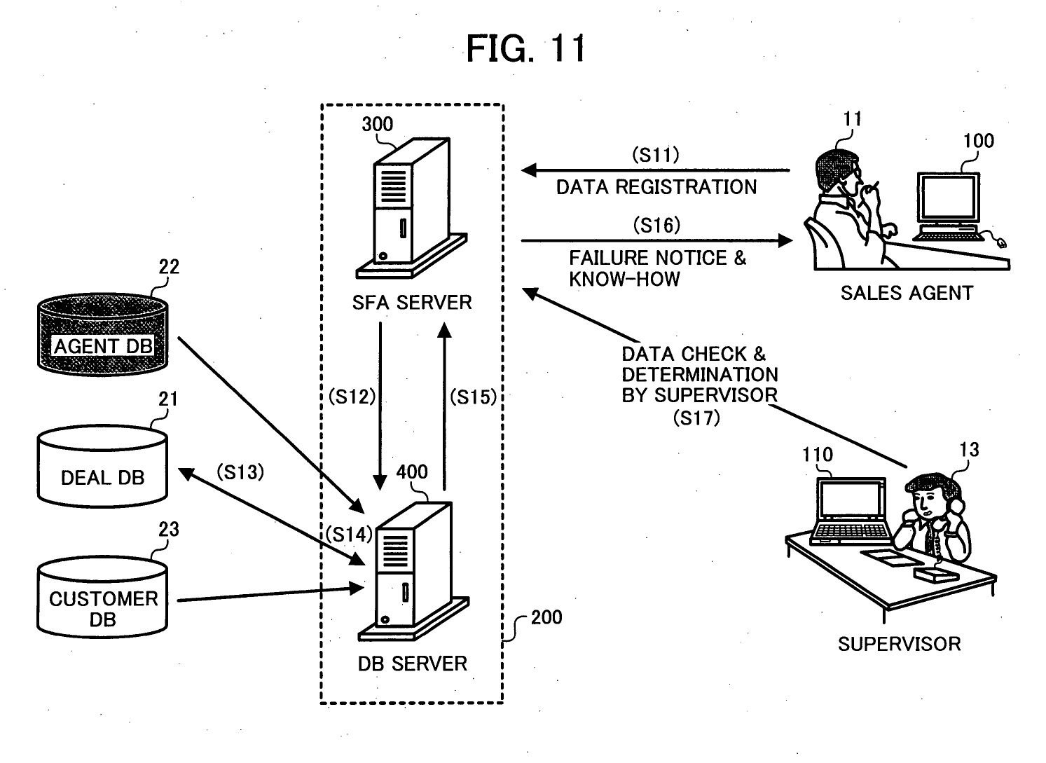

FIG. 11 is a schematic diagram exemplifying a still another configuration of the system 1. As shown in FIG. 11, the server 200 comprises the SFA server 300 and the DB server 400. Though the server 200 of this embodiment also comprises two different server devices as well as the embodiment shown in FIG. 10, the server 200 of this embodiment further comprises the agent DB 22 and the customer DB 23.

The sales agent 11 inputs deal data collected through daily sales activities to the SFA server 300 via the terminal device 100 (S11). The SFA server 300 transmits the input deal data to the DB server 400 (S12). The DB server 400 registers the deal data given by the SFA server 300 to the deal DB 21 deal by deal as deal activity history.

The DB server 400 analyzes the registered deal data to determine whether predetermined data items necessary for recognizing the deal status are failed or not. The DB server 400 retrieves deal data record in which some or all of the necessary data items are failed (S14). The DB server 400 further informs the SFA server 300 that predetermined necessary data items are failed from the retrieved record (S15). The DB server 400 may retrieve agent information including personal property data of the sales agent 11 from the agent DB 22, and customer information including personal property of the customer from the customer DB 23 at S14. In this case, the DB server 400 may transmit the retrieved information (agent information and customer information) to the SFA server 300 together with the notice of the failure. The above analysis and retrieval actions may be performed by the SFA server 300.

Then the SFA server 300 sets advisory information representing, for example, tips for getting information out of the customer in accordance with the agent information and/or the customer information. The SFA server 300 transmits the advisory information to the sales agent 11 together with the message asking the sales agent 11 to collect the failed information (S16). The supervisor 13 also refers the information transmitted to the sales agent 11 (S17).

The sales agent 11 to whom the message and the advisory information are sent from the SFA server 300 (message transmission function 200d) may contact the customer to collect information in accordance with the message with referring to the advisory tips. The SFA server 300 accepts the collected information from the sales agent 11, and registers the information to the deal DB 21. In response to the data entry in accordance with the message transmitted by the SFA server 300 (message transmission function 200d), the SFA server 300 transmits the registered deal data to the terminal device 110 (supervisor's terminal) deal by deal. Accordingly, the supervisor 13 is able to make decision whether the deal should be continued or not based on the deal data given by the SFA server 300.

As a modified embodiment, the SFA server 300 or the DB server 400 may make decision whether the deal should be continued or not in response to the data entry according to the message transmitted to the sales agent 11 from the SFA server 300 (message transmission function 200d). In this case, the SFA server 300 or the DB server 400 notifies the supervisor 13 and/or the sales agent 11 of the decision.

According to the above embodiments, it is able to provide advisory information in consideration of “advantages or disadvantages” of the sales agent 11 or “habits” of the customer 12, thus the sales agent 11 is informed how to get information out of the customer before collecting failed information necessary for recognizing the deal status. The supervisor 13 is able to make decision whether the deal should be continued or not quickly and finely just after the collected deal data are registered to the deal DB 21.

Though the system structures and functions have been mainly explained in the above embodiments, the present invention may be realized as “data collection supporting method”. The present invention is also realizable as computer program which makes the computer(s) function as the above described system. Such the computer program may be recorded on predetermined computer readable recording medium for distribution.

The programs and data necessary for realizing the functions of the present invention may be recorded on arbitrary recording media, such as CD-ROM, MO, DVD-ROM, FD, flash memory, memory card, various ROM and RAM, and the like. It is easy to distribute the programs to be executed by a computer to realize the above described functions after recording the programs on the above exemplified recording media. The programs may be loaded from such the recording medium or a predetermined storage in the computer to realize the functions of the present invention.

According to the present invention, it is helpful for improving data collection activities of the sales agents. Moreover, it is helpful for reducing management tasks of the supervisors.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2002-250725 filed on Aug. 29, 2002 and including specification, claims, drawings and summary. The disclosure of the above Japanese Patent Application is incorporated herein by reference in its entirety.

1. A data collection supporting system which includes a server which collects data regarding to deals from terminal devices being connected to said server via a network, comprising:
data input means for inputting the deal data collected by a sales agent to said server via said network;
data storing means for storing the deal data input by said data input means;
data analyzing means for analyzing the deal data stored by said data storing means, to determine whether predetermined data items necessary for recognizing the deal status are failed or not; and
failure notification means for notifying said sales agent that the input deal data have failure.

2. The system according to claim 1, wherein,
said failure notification means notifies said sales agent to collect information for the failed data items.

3. The system according to claim 1, wherein,
said failure notification means notifies said sales agent of know-how for getting information out of a customer.

4. A server being connected with terminal devices via a network, comprising:
a data collecting unit which collects data regarding to business deals from said terminal device operated by a sales agent via said network;
a database which stores the deal data collected by said data collecting unit so as to be associated with information of the sales agents and customers;
a data analyzer which analyzes the deal data stored in said database deal by deal to determine whether predetermined data items necessary for recognizing the status of each deal are failed or not;
a message generator which generates a message representing that the collected deal data have failures when the failure is found; and
a message transmitter which transmits the message generated by said message generator to said terminal devices operated by said sales agent via said network.

5. The server according to claim 4, wherein,
said message generator generates the message for requesting said sales agent to collect information regarding to the failed data items from the customer.

6. The server according to claim 4, wherein,
said data analyzer analyzes the deal data in said database deal by deal to determine whether the deal data of each deal are completed or not;
said message generator generates a message for requesting a supervisor of said sales agent to make business decision on the deal concerned, in a case where said data analyzer determines that the deal data concerned are completed; and
said message transmitter transmits the message to a terminal device operated by said supervisor via said network together with the deal data of the deal concerned.

7. The server according to claim 4, wherein,
said database further stores know-how data representing know-how for getting information out of a customer;
said data analyzer analyzes the deal data stored in said database to select know-how data; and
said message transmitter transmits the know-how data selected by said data analyzer to said terminal device operated by said sales agent.

8. The server according to claim 4, wherein,
said data analyzer analyzes the deal data stored in said database to determine whether the deal concerned should be continued or not.

9. A data collecting method for collecting data of business deals in a computer system including computers being connected from each other via a network, comprising the steps of:
collecting the deal data from a sale agent;
storing the collected deal data in a database;
analyzing the deal data in said database deal by deal to determine whether predetermined data items necessary for recognizing the deal status are failed from the deal data or not; and
notifying said sales agent that the deal data should be fulfilled, and requesting said sales agent to collect the failed information from a customer with notifying said sales agent of tips for getting information out of the customer, in a case where it is determined that the predetermined data items are failed.

10. The method according to claim 9, further comprising the steps of:
analyzing the deal data in said database to determine whether the deal data are completed or not;
requesting a supervisor of said sales agent to determine whether the deal should be continued or not, in a case where it is determined that the deal data for the deal concerned are completed.

11. A computer program product for causing a computer to execute a data collecting method comprising the steps of: collecting the deal data from a sale agent; storing the collected deal data in a database; analyzing the deal data in said database deal by deal to determine whether predetermined data items necessary for recognizing the deal status are failed from the deal data or not; notifying said sales agent that the deal data should be fulfilled, and requesting said sales agent to collect the failed information from a customer with notifying said sales agent of tips for getting information out of the customer when it is determined that the predetermined data items are failed; analyzing the deal data in said database to determine whether the deal data are completed or not; and requesting a supervisor of said sales agent to determine whether the deal should be continued or not, in a case where it is determined that the deal data for the deal concerned are completed.

12. A computer data signal embodied in a carrier wave for causing a computer to execute a data collecting method comprising the steps of: collecting the deal data from a sale agent; storing the collected deal data in a database; analyzing the deal data in said database deal by deal to determine whether predetermined data items necessary for recognizing the deal status are failed from the deal data or not; notifying said sales agent that the deal data should be fulfilled to request said sales agent to collect the failed information from a customer, together with tips for getting information out of the customer; analyzing the deal data in said database to determine whether the deal data are completed or not; and requesting a supervisor of said sales agent to determine whether the deal should be continued or not, in a case where it is determined that the deal data for the deal concerned are completed.
